(19) United States
(12) Patent Application Publication
(10) Pub. No.: US 2026/0045480 A1
(43) Pub. Date: Feb. 12, 2026

(54) METHOD FOR ENHANCING DRY ELECTRODE ELECTROLYTE ABSORPTION AND SEPARATOR ADHESION, AND SYSTEMS THEREOF

(71) Applicant: Tesla, Inc., Austin, TX (US)

(72) Inventors: Frederick Atadana, Fremont, CA (US); Pei Hsuan Lu, San Jose, CA (US); Timothy List, Aptos, CA (US); Meire Mehare, Oakland, CA (US); Shubham Patil, Milpitas, CA (US)

(21) Appl. No.: 18/799,923

(22) Filed: Aug. 9, 2024

(51) Int. Cl. H01M 4/04; H01M 4/02; H01M 4/505; H01M 4/525; H01M 4/62; H01M 10/0525; H01M 50/618

(52) U.S. Cl. CPC H01M 4/049; H01M 4/505; H01M 4/525; H01M 4/623; H01M 10/0525; H01M 50/618; H01M 2004/021; H01M 2004/027

(57) ABSTRACT

An activated electrode film comprising an active material and an activated binder, and methods thereof, are disclosed. An electrode film may be plasma treated to produce an activated electrode film comprising an activated binder. Such an activated electrode may quickly absorb an electrolyte to form a fully wet activated electrode.

### BACKGROUND

### Field

This disclosure relates to methods for fabricating electrode films for energy storage devices, and products thereof. In particular, the method relates to plasma treating electrode films.

### Description of the Related Art

Electrode films for typical energy storage devices include binder materials that are combined with active electrode materials. Generally, the electrodes are inserted into a housing with electrolyte, and the electrode films of the energy storage devices must be fully wetted with the electrolyte prior to operation. In dry electrode film manufacturing processes, a dry binder is combined with an active electrode material and calendered without the use of solvents to form a dry electrode film.

However, an energy storage device including a dry processed electrode may exhibit a slow electrolyte filling process and electrolyte wetting step, acting as key bottlenecks in assembly and manufacturing. Due to the slow electrolyte wetting step, electrodes must be stored until the wetting process is complete. Thus, the combination of the electrolyte filling process and the electrolyte wetting step requires large amounts of factory storage space.

Conventional methods addressing the electrolyte filling process may include the application of laser structuring or laser texturing, where the electrode material is partially removed by forming flow channels. However, the loss of electrode material and current collector in conventional methods may reduce energy storage device performance and may introduce challenges to the manufacturing processes.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, a method of fabricating an activated electrode film is described. The method includes: providing an electrode film comprising an active material and a binder; and plasma treating the electrode film with a plasma formed from an activating gas to form an activated electrode film comprising an activated binder.

In some embodiments, the activating gas comprises a gas selected from the group consisting of hydrogen gas, nitrogen gas, argon gas, oxygen gas and combinations thereof. In some embodiments, the activating gas comprises nitrogen gas at a concentration of at most about 0.1 vol. %. In some embodiments, plasma treating the electrode film operates at a pressure of at most about 5 atm. In some embodiments, plasma treating the electrode film operates at a pressure of about 0 atm.

In some embodiments, the activated electrode film is substantially free of solvent residue. In some embodiments, the activated electrode film is disposed over a current collector to form an activated electrode. In some embodiments, the binder is a fluorinated binder. In some embodiments, the activated binder is selected from the group consisting of a defluorinated binder, a hydroxylated binder, and combinations thereof.

In another aspect, a method of preparing an energy storage device is described. The method includes: disposing an activated electrode within a housing; and disposing an electrolyte within the housing, wherein the activated electrode absorbs the electrolyte to form a fully wet activated electrode. In some embodiments, the electrolyte is disposed after the activated electrode is disposed within the housing. In some embodiments, the energy storage device absorbs the electrolyte to form a fully soaked electrode energy storage device in at most about 5 hours. In some embodiments, the method further comprises enabling complete wetting of the activated electrode in less than about 3 hours. In some embodiments, the electrolyte fills the activated electrode at a positive interfacial pressure. In some embodiments, the positive interfacial pressure is at least about 1 atm. In some embodiments, the filling of the electrolyte does not comprise an additional external pressure.

In one aspect, an activated electrode film is described. The activated electrode film includes: an active material; and an activated binder.

In some embodiments, the activated electrode film further comprises at least 90 wt. % of the active material. In some embodiments, the active material is selected from at least one of a metal oxide, metal sulfide, a sulfur-carbon composite, a lithium metal oxide, and a material including sulfur. In some embodiments, the activated electrode film further comprises at most about 5 wt. % of the activated binder. In some embodiments, the activated binder is selected from the group consisting of defluorinated polyvinylidene fluoride (PVDF), defluorinated polytetrafluoroethylene (PTFE), polyethylene (PE), polypropylene (PP), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, carboxymethylcellulose (CMC), co-polymers thereof and combinations thereof. In some embodiments, the activated binder is selected from the group consisting of a defluorinated binder, a hydroxylated binder, and combinations thereof.

In some embodiments, the activated electrode film is substantially free of solvent residue. In some embodiments, the activated electrode film comprises at most about 1 wt. % of non-activated binder. In some embodiments, the activated electrode film further comprises an activated film thickness comprising the activated binder. In some embodiments, the activated film thickness is at least about 20 μm. In some embodiments, the activated electrode film comprises a contact angle of at most about 20°. In some embodiments, the activated electrode film comprises a contact angle of about 0°.

### BRIEF DESCRIPTION OF THE DRAWINGS

FIG. 1 is a flowchart showing a method of fabricating an activated electrode film with plasma, according to some embodiments.

FIG. 2A is an illustration of a non-activated electrode film surface.

FIG. 2B is an illustration of an activated electrode film surface subsequent to plasma treatment.

FIG. 3 is a schematic illustration of a plasma system for fabricating an activated electrode film, according to some embodiments.

FIG. 4A is a schematic of cross sections of a jellyroll energy storage device using non-activated electrodes.

FIG. 4B is a schematic of cross sections of a jellyroll energy storage device using activated electrodes, according to some embodiments.

FIG. 5A is an image of liquid droplets on a non-activated electrode film using an atmospheric plasma treating process, according to some embodiments.

FIG. 5B is an image of liquid droplets on an activated electrode film using an atmospheric plasma treating process, according to some embodiments.

FIG. 5C is an image of a liquid droplet on a non-activated electrode film using a vacuum plasma treating process, according to some embodiments.

FIG. 5D is an image of a liquid droplet on an activated electrode film using a vacuum plasma treating process, according to some embodiments.

FIG. 6A is a data plot showing contact angle vs. plasma treatment time on a dry anode and cathode, according to some embodiments.

FIG. 6B is an image of a liquid droplet on an activated dry anode before plasma treatment.

FIG. 6C is an image of a liquid droplet on an activated dry anode at about 10 minutes of plasma treatment time, according to some embodiments.

FIG. 6D is an image of a liquid droplet on an activated dry cathode before plasma treatment.

FIG. 6E is an image of a liquid droplet on an activated dry cathode at about 10 minutes of plasma treatment time, according to some embodiments.

FIG. 7A is a data plot showing wetting % vs. duration comparing plasma treated dry electrodes, according to some embodiments, against untreated dry electrodes.

FIG. 7B is an image of dry spots on an untreated electrode, according to some embodiments.

FIG. 7C is an image of a fully wet plasma treated electrode, according to some embodiments.

FIG. 7D is an image of dry and wet areas on electrodes, according to some embodiments.

FIG. 7E is a data plot showing soak % vs. duration comparing plasma treated dry electrodes, according to some embodiments against untreated dry electrodes.

FIG. 8 is a data plot showing a summary of energy storage device performances based on soaking time comparing plasma treated dry electrodes, according to some embodiments, against untreated dry electrodes.

FIG. 9A is a data plot showing a summary of energy storage device performances based on cell energy loss comparing plasma treated dry electrodes, according to some embodiments, against untreated dry electrodes.

FIG. 9B is a data plot showing a summary of energy storage device performances based on cell capacity loss comparing plasma treated dry electrodes, according to some embodiments, against untreated dry electrodes.

FIG. 10A is an image showing a separator that was adhered to a non-activated electrode film and subsequently removed from the non-activated electrode film.

FIG. 10B is an image showing a separator that was adhered to an activated electrode film and subsequently removed from the activated electrode film.

FIG. 10C is an image showing various separators that were adhered to activated and non-activated electrode films using one plasma type, according to some embodiments, and subsequently removed from the electrode films at 45° C.

FIG. 10D is an image comparing various separators that were adhered to activated and non-activated electrode films using two different plasma types, according to some embodiments, and subsequently removed from the electrode films at 45° C.

FIG. 10E is an image comparing various separators that were adhered to activated and non-activated electrode films using two different plasma types, according to some embodiments, and subsequently removed from the electrode films at 60° C.

It will be clearly understood though, that the examples and figures are for illustrative purpose only, and are not necessarily restrictive of the scope of the present invention.

### DETAILED DESCRIPTION

Although certain preferred embodiments and examples are disclosed below, the inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations, in turn, in a manner that may be helpful in understanding certain embodiments; however, the order of description should not be construed to imply that these operations are order-dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Methods of fabricating activated electrode films and activated electrodes using a plasma are described. Generally, an electrode film comprising binders (e.g., fluorinated binders, low surface energy binders) have poor wetting characteristics on the electrode film. As such, plasma treatment functionalizes the binder (e.g., fluorinated binder, low surface energy binder) to form an activated binder (e.g., defluorinated binder, hydroxylated binder, high surface energy binder), thereby increasing surface energy and enabling enhancement of electrolyte absorption. An activated binder is created when a plasma formed from an activating gas modifies the chemistry of the binder, for example such as removing fluorine and/or hydrogen groups from binders and/or replacing them with hydroxyl groups.

As a result of forming activated binders, an activated electrode film enhances electrolyte absorption, helps reduce electrolyte filling time and wetting time in energy storage device assemblies, improves material adhesion and bonding, fills electrolytes without or with reduced pressures, reduces costs for assembly equipment and manufacturing complexity, and/or increase cell reliability. For example, while an electrolyte filling process requires high external pressures and may lead to an initial electrode cell stiffness loss of at least about 50%, plasma treated electrodes with a reduced contact angle can enhance flow of electrolytes into the electrode without or with reduced need of external pressures. As such, by utilizing activated electrodes for the preparation of energy storage device fabrication, the total cost of assembly and factory space may be reduced, core collapse may be mitigated or eliminated, and the initial electrode cell stiffness can be maintained (e.g., at, at about, at most, or at most about, 1%, 5% 10%, 20%, 30% or any range of values therebetween, of initial electrode cell stiffness loss).

### Plasma Fabricating Activated Electrode Films and Activated Electrodes

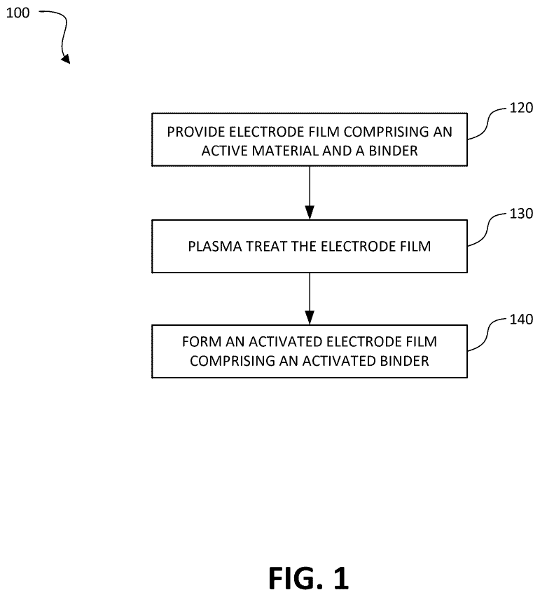

An activated electrode film is produced or formed as a product of plasma treating an electrode film. FIG. 1 is a flowchart showing one method or activation process 100 of fabricating an activated electrode film with plasma according to some embodiments. As shown in FIG. 1, an electrode film comprising an active material and a binder (e.g., fluorinated binder, low surface energy binder) is provided 120, and the electrode film is plasma treated 130 to form an activated electrode film comprising an activated binder 140 (e.g., defluorinated binder, hydroxylated binder, high surface energy binder).

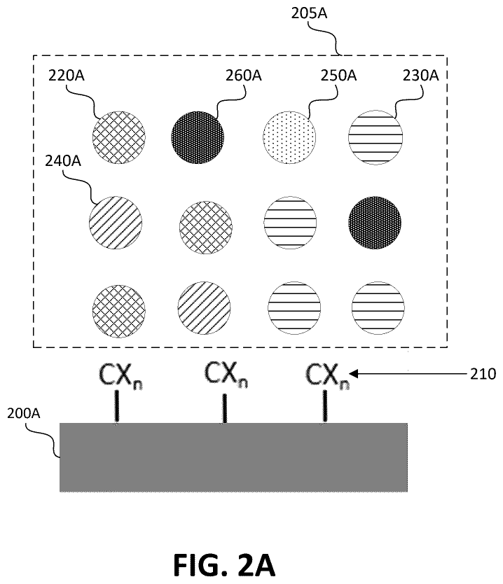

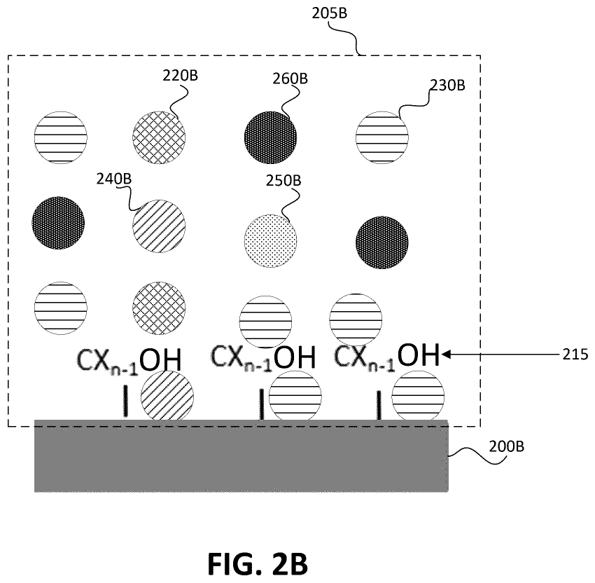

A non-activated electrode film includes an unmodified electrode film surface, and an activated electrode film includes a modified electrode film surface formed by plasma treatment (e.g., using atmospheric pressures, pressurized environments, vacuum environments, and/or activating gas compositions). FIG. 2A is an illustration of a non-activated electrode film surface 200A, with a binder substituent group 210 (denoted by CXₙ). In some embodiments, each X group can be a fluorine group, hydrogen group or a hydrocarbon group. A plasma formed based on gas compositions generates different types of ions 205A including nitrogen ions 220A, hydrogen ions 230A, oxygen ions 240A, argon ions 250A, and electrons 260A over the non-activated electrode film surface 200A. As shown in FIG. 2A, the binder substituent groups 210 are unmodified or not yet modified by any of the plasma ions 205A.

FIG. 2B is an illustration of an activated electrode film surface 200B after plasma treatment, where an activated binder substituent group 215 (denoted by CXₙ₋₁OH) is formed by substituting an “X” element (e.g., hydrocarbon group, F or H) with a hydroxyl group. A plasma formed based on gas compositions generates different types of ions 205B including nitrogen ions 220B, hydrogen ions 230B, oxygen ions 240B, argon ions 250B, and electrons 260B over the activated electrode film surface 200B. As shown in FIG. 2B, the binder substituent groups are modified by the plasma ions 205B to form activated binder substitute groups 215.

In some embodiments, the binder includes a low surface energy polymer. In some embodiments, the binder substituent group includes fluoride, hydrogen, or combinations thereof. In some embodiments, binder substituent groups are replaced with hydroxyl groups (i.e., OH) to form the activated binder. In some embodiments, the activated electrode film replaces fluoride groups with hydroxyl groups.

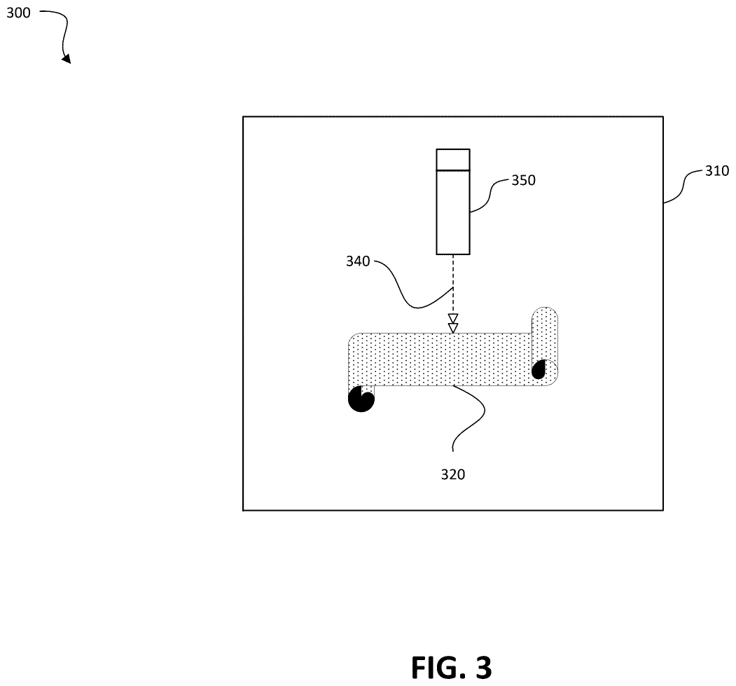

A plasma system may be used in a vacuum, non-pressurized (i.e., atmospheric pressure) or pressurized enclosure (e.g., a chamber). FIG. 3 is a schematic illustration of a plasma system for fabricating an activated electrode film, according to some embodiments. The plasma system 300 includes a plasma chamber 310, and an electrode film 320 is disposed within the plasma chamber 310. A plasma source 350 is used to treat the electrode film 320 with a plasma 340, thereby forming an activated electrode film.

The plasma may be formed from an activating gas. In some embodiments, the activating gas includes a defluorinating gas, a hydroxylating gas, and combinations thereof. In some embodiments, the activating gas comprises a gas selected from the group consisting of hydrogen gas, nitrogen gas, argon gas, oxygen gas, and combinations thereof. In some embodiments, the activating gas in vacuum conditions comprises a hydrogen gas concentration of, of about, of at most, or of at most about 100 vol. %. In some embodiments, the activating gas in atmospheric conditions comprises a hydrogen gas concentration between 0 vol. % to 5 vol. % mixed with nitrogen gas concentration or argon gas concentration between 95 vol. % to 100 vol. %. In some embodiments, the activating gas in a pressurized system comprises a hydrogen gas concentration between 0 vol. % to 5 vol. % mixed with argon gas concentration or nitrogen gas concentration between 95 vol. % to 100 vol. %. In some embodiments, nitrogen gas is used in atmospheric or pressurized conditions. In some embodiments, the activating gas comprises a nitrogen gas concentration of, of about, of at most, or of at most about 100 vol. %. In some embodiments, the activating gas comprises an oxygen gas concentration of, of about, of at most, or of at most about 21 vol. % mixed with a nitrogen gas concentration of, of about, of at most, or of at most about 79 vol. %. In some embodiments, the activating gas comprises hydrogen gas concentration of, of about, of at most, or of at most about, 100 vol. %. In some embodiments, the activating gas comprises hydrogen gas concentration of, of about, of at most, or of at most about, 0.001 vol. %, 0.005 vol. %, 0.01 vol. %, 0.03 vol. %, 0.05 vol. %, 0.06 vol. %, 0.07 vol. %, 0.08 vol. %, 0.09 vol. %, 0.1 vol. %, 0.2 vol. %, 0.3 vol. %, 0.4 vol. %, 0.5 vol. %, 1 vol. %, 2 vol. %, 3 vol. % or 5 vol. %, or any range of values therebetween. In some embodiments, the activating gas comprises nitrogen gas concentration of, of about, of at most, or of at most about, 95 vol. %, 96 vol. %, 97 vol. %, 98 vol. %, 99 vol. % or 100 vol. %, or any range of values therebetween. In some embodiments, the activating gas comprises nitrogen gas concentration of, of about, of at most, or of at most about, 0.001 vol. %, 0.005 vol. %, 0.01 vol. %, 0.03 vol. %, 0.05 vol. %, 0.06 vol. %, 0.07 vol. %, 0.08 vol. %, 0.09 vol. %, 0.1 vol. %, 0.2 vol. %, 0.3 vol. %, 0.4 vol. %, 0.5 vol. %, 1 vol. %, 2 vol. %, 3 vol. % or 5 vol. %, or any range of values therebetween. In some embodiments, the activating gas comprises argon gas concentration of, of about, of at most, or of at most about, 95 vol. %, 96 vol. %, 97 vol. %, 98 vol. %, 99 vol. % or 100 vol. %, or any range of values therebetween. In some embodiments, the activating gas comprises argon gas concentration of, of about, of at most, or of at most about, 0.001 vol. %, 0.005 vol. %, 0.01 vol. %, 0.03 vol. %, 0.05 vol. %, 0.06 vol. %, 0.07 vol. %, 0.08 vol. %, 0.09 vol. %, 0.1 vol. %, 0.2 vol. %, 0.3 vol. %, 0.4 vol. %, 0.5 vol. %, 1 vol. %, 2 vol. %, 3 vol. % or 5 vol. %, or any range of values therebetween. In some embodiments, the activating gas comprises oxygen gas concentration of, of about, of at most, or of at most about, 0.001 vol. %, 0.005 vol. %, 0.01 vol. %, 0.03 vol. %, 0.05 vol. %, 0.06 vol. %, 0.07 vol. %, 0.08 vol. %, 0.09 vol. %, 0.1 vol. %, 0.2 vol. %, 0.3 vol. %, 0.4 vol. %, 0.5 vol. %, 1 vol. %, 2 vol. %, 3 vol. %, 5 vol. %, 7 vol. %, 9 vol. %, 11 vol. %, 13 vol. %, 15 vol. %, 17 vol. %, 19 vol. % or 21 vol. %, or any range of values therebetween. The plasma includes charged particles formed from the activating gas. In some embodiments, the charged particles include nitrogen ions, hydrogen ions, oxygen ions, argon ions, electrons, and combinations thereof.

The plasma treatment may be operated at various conditions including but not limited to plasma power, temperature, pressure, duration, and flow rate to achieve an activated binder of the electrode film at various amounts and depths. In some embodiments, plasma treating the electrode film may include operation at a pressure of, of about, of at most, or of at most about, 0 atm, 0.1 atm, 0.2 atm, 0.3 atm, 0.4 atm, 0.5 atm, 0.6 atm, 0.7 atm, 0.8 atm, 0.9 atm, 1 atm, 2 atm, 3 atm, 4 atm or 5 atm, or any range of values therebetween. In some embodiments, a duration of plasma treatment may be at a time of, of about, of at least, or of at least about, 0.1 seconds, 0.2 seconds, 0.3 seconds, 0.4 seconds, 0.5 seconds, 0.6 seconds, 0.7 seconds, 0.8 seconds, 0.9 seconds, 1 seconds, 2 seconds, 3 seconds, 4 seconds, 5 seconds, 6 seconds, 7 seconds, 8 seconds, 9 seconds or 10 seconds, or any range of values therebetween. In some embodiments, a plasma is configured to cause activation of an electrode film at a film thickness or depth from the surface of, of about, of at least, or of at least about, 0.5 μm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm or 20 μm, or any range of values therebetween. In some embodiments, plasma treating the electrode film may include a plasma flow rate of, of about, of at least, or of at least about, 0.1 L/min, 0.2 L/min, 0.3 L/min, 0.4 L/min, 0.5 L/min, 0.6 L/min, 0.7 L/min, 0.8 L/min, 0.9 L/min, 1 L/min, 2 L/min, 3 L/min, 4 L/min, 5 L/min, 6 L/min, 7 L/min, 8 L/min, 9 L/min, 10 L/min, 20 L/min, 30 L/min, 40 L/min, 50 L/min, 60 L/min, 70 L/min, 80 L/min, 90 L/min or 100 L/min, or any range of values therebetween.

In some embodiments, the electrode film prior to plasma treatment may be at a pre-treatment temperature of, of about, of at most, or of at most about, 15° C., 16° C., 17° C., 18° C., 19° C., 20° C., 21° C., 22° C., 23° C., 24° C., 25° C., 26° C., 27° C., 28° C., 29° C. or 30° C., or any range of values therebetween. In some embodiments, the electrode film after plasma treatment may be at a post-treatment temperature of, of about, of at most, or of at most about, 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C. or 60° C., or any range of values therebetween. In some embodiments, the electrode film is a free-standing electrode film. In some embodiments, the free-standing electrode film is plasma treated. In some embodiments, the electrode film is not free-standing and is incorporated into an electrode with a supporting element such as a current collector or another electrode film. In some embodiments, the electrode film that is not free-standing is plasma treated.

In some embodiments, the electrode film is plasma treated in atmospheric conditions. In some embodiments, atmospheric conditions are absent of any external pressure conditions and/or vacuum conditions. In some embodiments, the electrode film is plasma treated in a non-pressurized chamber. In some embodiments, the electrode film is plasma treated in a pressurized chamber. In some embodiments, the electrode film is plasma treated in a vacuum chamber. In some embodiments, a double-sided electrode comprises at least two electrode films, wherein the two electrode films of the double-sided electrode are plasma treated in a non-pressurized chamber. In some embodiments, the two electrode films of the double-sided electrode are plasma treated in a pressurized chamber. In some embodiments, the electrode film is plasma treated by a number of plasma sources. In some embodiments, the number of plasma sources may comprise at least 1, 2, 3, 4, 5, 6, 7, 8, 9, 10, 11, 12, 13, 14, 15, 16, 17, 18, 19 or 20 plasma sources.

In some embodiments, plasma treating the electrode film may include an operating power of, of about, of at least, or of at least about, 200 W, 210 W, 220 W, 230 W, 240 W, 250 W, 260 W, 270 W, 280 W, 290 W, 300 W, 310 W, 320 W, 330 W, 340 W, 350 W, 360 W, 370 W, 380 W, 390 W, 400 W, 410 W, 420 W, 430 W, 440 W, 450 W, 460 W, 470 W, 480 W, 490 W or 500 W, or any range of values therebetween. In some embodiments, plasma treating the electrode film may include an operating power of, of about, of at least, or of at least about, 3000 W, 3100 W, 3200 W, 3300 W, 3400 W, 3500 W 3600 W, 3700 W, 3800 W 3900 W or 4000 W, or any range of values therebetween.

### Activated Electrode Films and Activated Electrodes

A non-activated electrode film, including a binder, or a non-activated electrode thereof may be activated to form an activated electrode film, with an active material and an activated binder, and activated electrodes thereof. In some embodiments, the electrode film (e.g., non-activated electrode film, activated electrode film) is or is substantially free of solvent residue. In some embodiments, the non-activated electrode film includes, includes about, includes at least, or includes at least about, 90 wt. %, 91 wt. %, 92 wt. %, 93 wt. %, 94 wt. %, 95 wt. %, 96 wt. %, 97 wt. %, 98 wt. % or 99 wt. %, or any range of values therebetween, of the active material.

In some embodiments, the active material is a cathode active material, an anode active material, or combinations thereof. In some embodiments, the cathode active material is selected from at least one of a metal oxide, metal sulfide, a sulfur-carbon composite, a lithium metal oxide, and a material including sulfur. In some embodiments, the cathode active material is selected from lithium iron phosphate (i.e., LiFePO₄ or “LFP”), lithium manganese iron phosphate (e.g., LiMn_{0.6}Fe_{0.4}PO₄ or “LMFP”), lithium nickel manganese cobalt oxide (i.e., LiNiₓMn_{y}Co_{1-x-y}O₂ or “NMC”), lithium nickel cobalt aluminum oxide (i.e., LiNiₓCo_{y}Al_{z}O₂ or “NCA”), lithium manganese oxide (“LMO”), lithium nickel manganese oxide (“LNMO”), lithium cobalt oxide (“LCO”), lithium titanate (“LTO”), or combinations thereof. In some embodiments, the cathode active material includes at least two of LFP, LMFP, NMC, NCA, LMO, LNMO, LCO, LTO, and combinations thereof.

In some embodiments, anode active materials can include, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx-C, SnOx-C, Si—Sn, Si—SiOx, Sn-SnOx, Si-SiOx-C, Sn—SnOx-C, Si—Sn—C, SiOx-SnOx-C, Si—SiOx-Sn, or Sn-SiOx-SnOx). Anode active materials include common natural graphite, synthetic or artificial graphite, surface modified graphite, spherical-shaped graphite, flake-shaped graphite and blends or combinations of these types of graphite, metallic elements and its compound as well as metal-C composite for anode.

In some embodiments, the electrode film (e.g., non-activated electrode film, activated electrode film) includes, includes about, includes at most, or includes at most about, 1 wt. %, 2 wt. %, 3 wt. %, 4 wt. %, 5 wt. %, 6 wt. %, 7 wt. %, 8 wt. %, 9 wt. %, 10 wt. %, or any range of values therebetween, of a binder. In some embodiments, the activated electrode film includes, includes about, includes at most, or includes at most about, 1 wt. %, 2 wt. %, 3 wt. %, 4 wt. %, 5 wt. %, 6 wt. %, 7 wt. %, 8 wt. %, 9 wt. %, 10 wt. %, or any range of values therebetween, of the activated binder. In some embodiments, the activated electrode film includes, includes about, includes at most, or includes at most about, 1 wt. %, 2 wt. %, 3 wt. %, 4 wt. % or 5 wt. % or any range of values therebetween, of the activated binder (e.g., defluorinated binder, hydroxylated binder, high surface energy binder). In some embodiments, the binder (e.g., fluorinated binder, low surface energy binder) is selected from polyvinylidene fluoride (PVDF), polytetrafluoroethylene (PTFE), polyvinylfluoride (PVF), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoroethylene (ECTFE), perfluorinated elastomer, fluoroelastomer, perfluoropolyether (PFPE), polyethylene (PE), polypropylene (PP), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, carboxymethylcellulose (CMC), co-polymers thereof and combinations thereof. In some embodiments, the binder (e.g., fluorinated binder, low surface energy binder) is selected from polyvinylidene fluoride (PVDF), polytetrafluoroethylene (PTFE), polyvinylfluoride (PVF), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoroethylene (ECTFE), perfluorinated elastomer, fluoroelastomer, perfluoropolyether (PFPE), co-polymers thereof and combinations thereof. In some embodiments, the activated (e.g., defluorinated, hydroxylated, high surface energy) binder is selected from activated polyvinylidene fluoride (PVDF), activated polytetrafluoroethylene (PTFE), activated polyvinylfluoride (PVF), activated polychlorotrifluoroethylene (PCTFE), activated perfluoroalkoxy polymer (PFA), activated ethylene-propylene (FEP), activated polyethylenetetrafluoroethylene (ETFE), activated polyethylenechlorotrifluoroethylene (ECTFE), activated perfluorinated elastomer, activated fluoroelastomer, activated perfluoropolyether (PFPE), activated polyethylene (PE), activated polypropylene (PP), activated poly(ethylene oxide) (PEO), activated poly(phenylene oxide) (PPO), activated polyethylene-block-poly(ethylene glycol), activated polydimethylsiloxane (PDMS), activated polydimethylsiloxane-coalkylmethylsiloxane, carboxymethylcellulose (CMC), co-polymers thereof and admixtures thereof. In some embodiments, the electrode film (e.g., non-activated electrode film, activated electrode film) includes, includes about, includes at most, or includes at most about, 0.1 wt. %, 0.5 wt. %, 1 wt. %, 2 wt. %, 3 wt. %, 5 wt. %, 8 wt. %, 10 wt. %, 15 wt. %, 20 wt. %, 25 wt. %, 30 wt. %, 40 wt. %, 50 wt. %, 60 wt. % or 70 wt. % of binder, or any range of values therebetween.

In some embodiments, an electrode film (e.g., non-activated electrode film, activated electrode film) comprises a carbon material configured to reversibly intercalate lithium ions. In some embodiments, the electrode film (e.g., non-activated electrode film, activated electrode film) comprises the carbon material in a total amount of, of about, of at most, or at most about, 20 wt. %, 15 wt. %, 10 wt. %, 9 wt. %, 8 wt. %, 7 wt. %, 6 wt. %, 5 wt. %, 4 wt. %, 3 wt. %, 2 wt. %, 1 wt. %, or any range of values therebetween. In some embodiments, the lithium intercalating carbon is selected from a graphitic carbon, graphite, hard carbon, soft carbon and combinations thereof. For example, the electrode film of the electrode can include a binder material, one or more of graphitic carbon, graphite, graphene-containing carbon, hard carbon and soft carbon, and an electrical conductivity promoting material. In some embodiments, an electrode is mixed with lithium metal and/or lithium ions.

In some embodiments, an electrode film (e.g., non-activated electrode film, activated electrode film) includes a conductive additive. In some embodiments, the conductive additive may comprise a conductive carbon additive. In some embodiments, the conductive carbon additive comprises a carbon black, carbon nanotubes, such as single-walled carbon nanotubes (SWCNTs) and multi-walled carbon nanotubes (MWCNTs). In some embodiments, the electrode film comprises the conductive additive in a total amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, or any range of values therebetween. In some embodiments, each of the conductive additive is in an amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, of the electrode film, or any range of values therebetween. In some embodiments, the conductive additive is carbon black.

In some embodiments, the electrode film (e.g., non-activated electrode film, activated electrode film) comprises a thickness of, of about, of at most, or at most about, 1000 μm, 900 μm, 800 μm, 700 μm, 600 μm, 500 μm, 400 μm, 300 μm, 250 μm, 200 μm, 150 μm, 100 μm, 90 μm, 80 μm, 70 μm, 60 μm, 50 μm, 40 μm, 30 μm, 20 μm, 15 μm, 10 μm, or any range of values therebetween. In some embodiments, the electrode film may provide an active material loading (which may be expressed as mass of electrode film per unit area of electrode film or current collector) of, of about, of at least, of at least about 3 mg/cm², 4 mg/cm², 5 mg/cm², 10 mg/cm², 15 mg/cm², 20 mg/cm², 30 mg/cm², 40 mg/cm², 50 mg/cm², 100 mg/cm², or any range of values therebetween.

In some embodiments, the activated binder is positioned within an activated film thickness of the electrode film. In some embodiments, the activated film thickness is, is about, is at least, or is at least about, 0.5 μm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 50 μm, 100 μm, 200 μm, 300 μm, 400 μm, 500 μm, 600 μm, 700 μm, 800 μm, 900 μm or 1000 μm, or any range of values therebetween.

As used herein, the term, “contact angle” refers to the angle between a liquid (e.g., water, an electrolyte) and a surface. In some embodiments, the contact angle a liquid makes with the electrode film (e.g., non-activated electrode film, activated electrode film) is about 0°, 1°, 2°, 3°, 4°, 5°, 6°, 7°, 8°, 9°, 10°, 11°, 12°, 13°, 14°, 15°, 16°, 17°, 18°, 19° or 20°, or any range of values therebetween.

In some embodiments, the electrode film (e.g., non-activated electrode film, activated electrode film) can be a wet processed electrode film. In some embodiments, the electrode film is prepared by a wet or slurry-based electrode fabrication process. In some embodiments, the electrode film of the present disclosure can be a dry processed electrode film. In some embodiments, the electrode film is prepared by a dry electrode fabrication process. As used herein, a dry electrode fabrication process can refer to a process in which no or substantially no solvents are used to form a dry electrode film. For example, components of the active layer or electrode film, including carbon materials and binders, may comprise, consist of, or consist essentially of dry particles. The dry particles for forming the active layer or electrode film may be combined to provide a dry particle active layer mixture. In some embodiments, the active layer or electrode film may be formed from the dry particle active layer mixture such that weight percentages of the components of the active layer or electrode film and weight percentages of the components of the dry particles active layer mixture are substantially the same. In some embodiments, the active layer or electrode film formed from the dry particle active layer mixture using the dry fabrication process may be free from, or substantially free from, any processing additives such as solvents and solvent residues resulting therefrom. In some embodiments, the resulting active layer or electrode films are self-supporting films formed using the dry process from the dry particle mixture. In some embodiments, the resulting active layer or electrode films are free-standing films formed using the dry process from the dry particle mixture. A process for forming an active layer or electrode film can include fibrillizing the fibrillizable binder component(s) such that the film comprises fibrillized binder. In further embodiments, a free-standing active layer or electrode film may be formed in the absence of a current collector. In still further embodiments, an active layer or electrode film may comprise a fibrillized polymer matrix such that the film is self-supporting. It is thought that a matrix, lattice, or web of fibrils can be formed to provide mechanical structure to the electrode film.

A “self-supporting” electrode film is an electrode film that incorporates binder matrix structures sufficient to support the film or layer and maintain its shape such that the electrode film or layer can be free-standing. When incorporated in an energy storage device, a self-supporting electrode film or active layer is one that incorporates such binder matrix structures. Generally, and depending on the methods employed, such electrode films or active layers are strong enough to be employed in energy storage device fabrication processes without any outside supporting elements, such as a current collector or other film. For example, a “self-supporting” electrode film can have sufficient strength to be rolled, handled, and unrolled within an electrode fabrication process without other supporting elements. A dry electrode film, such as a cathode electrode film or an anode electrode film, may be self-supporting.

In some embodiments, an electrode film is disposed on a current collector to form an electrode (e.g., non-activated electrode, activated electrode). In some embodiments, a current collector can include a metallic material, such as a material comprising aluminum, nickel, copper, combinations of the foregoing. In some embodiments, a current collector comprises a pure metal. In some embodiments, a current collector comprises a metallized polymer film or metal coated polymer film. In some embodiments, the polymer comprises polyethylene terephthalate (PET), biaxially oriented polypropylene (BOPP) or a combination thereof. In some embodiments, the metal coating comprises aluminum. In some embodiments, coating the final electrode film mixture comprises forming a uniform electrode film mixture coating. In some embodiments, the current collector comprises a thickness of, of about, of at most, or at most about, 200 μm, 100 μm, 50 μm, 40 μm, 30 μm, 20 μm, 15 μm, 10 μm, 5 μm, or any range of values therebetween.

In some embodiments, an electrode (e.g., non-activated electrode, activated electrode) is a double-sided electrode. In some embodiments, the double-sided electrode includes two electrode films. In some embodiments, the double-sided electrode may include a current collector, a top electrode film, and a bottom electrode film. In some embodiments, each of the two electrode films can have any suitable shape, size and thickness.

### Energy Storage Devices and Methods of Fabrication

An energy storage device includes a positive electrode (i.e., cathode), a negative electrode (i.e., anode), a separator disposed therebetween, and an electrolyte positioned within a housing. Each electrode includes an electrode film disposed over a current collector. In some embodiments, the energy storage devices may be a battery, capacitor, capacitor-battery hybrid, fuel cell, or combinations thereof. In some embodiments, the energy storage device may be used in motor vehicles, including hybrid electric vehicles (HEV), plug-in hybrid electric vehicles (PHEV), and/or electric vehicles (EV).

In some embodiments, a method of preparing an energy storage device includes disposing an activated electrode within a housing and disposing an electrolyte within the housing, wherein the activated electrode absorbs the electrolyte to form a wet activated electrode. In some embodiments, the electrolyte is disposed in the housing before, after and/or concurrently with the disposing of the activated electrode within the housing. In some embodiments, the energy storage device and/or wet activated electrode is processed so that the wet activated electrode absorbs the electrolyte to form a fully wet activated electrode. In some embodiments, the fully wet activated electrode is incapable of or of substantially absorbing additional electrolyte.

In some embodiments, charging an energy storage device with electrolytes includes (e.g., only includes) soaking the activated electrode in the electrolyte, wherein the activated electrode comes in contact with the electrolyte and fills the activated electrode with electrolytes. In some embodiments, a positive interfacial pressure can be generated to enhance flow of electrolytes into the electrode without the need of external pressure. In some embodiments, the positive interfacial pressure is, is about, is at least, or at least about, 1 atm, 2 atm, 3 atm, 4 atm or 5 atm, or any range of values therebetween. In some embodiments, the filling of the electrolyte comprises an additional external pressure of, of about, of at most, or at most about, 0 atm, 0.1 atm, 0.2 atm, 0.3 atm, 0.4 atm, 0.5 atm, 0.6 atm, 0.7 atm, 0.8 atm, 0.9 atm, 1 atm, 2 atm, 3 atm, 4 atm or 5 atm, or any range of values therebetween. In some embodiments, the positive interfacial pressure enables the electrolyte to be gravity filled into the energy storage device. In some embodiments, the electrolyte is gravity filled into the energy storage device. In some embodiments, the filling of the electrolyte does not comprise an additional external pressure. In some embodiments, the filling of the electrolyte does not include pressurizing the energy storage device.

In some embodiments, the activated electrode film when exposed to electrolyte becomes fully wet in, in about, in at most, or in at most about, 0.5 hours, 1 hour, 1.5 hours, 2 hours, 2.5 hours, 3 hours or 3.5 hours, or any range of values therebetween. In some embodiments, the non-activated electrode film becomes fully wet in, in about, in at most, or in at most about, 4 hours, 4.5 hours, 5 hours, 6 hours, 7 hours, 8 hours, 9 hours, 10 hours, 11 hours, 12 hours, 13 hours, 14 hours, 15 hours, 16 hours, 18 hours or 20 hours, or any range of values therebetween.

In some embodiments, the energy storage device is charged with a suitable lithium-containing electrolyte. For example, the energy storage device can include a lithium salt, and a solvent, such as a non-aqueous or organic solvent. Generally, the lithium salt includes an anion that is redox stable. In some embodiments, the anion can be monovalent. In some embodiments, a lithium salt can be selected from lithium hexafluorophosphate (LiPF₆), lithium bis(trifluoromethanesulfonyl)imide (LiFSI), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), lithium bis(oxalate)borate (LiB(C₂O₄)₂), lithium bis(fluorosulfonyl)imide (LiN(SO₂F)₂, lithium difluoro(oxalate)borate (LiC₂BF₂O₄) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 2 M. In certain embodiments, the salt concentration of the electrolyte can be about 0.2 M, about 0.3 M, about 0.4 M, about 0.5 M, about 0.6 M, about 0.7 M, about 0.8 M, about 0.9 M, about 1 M, about 1.1 M, about 1.2 M, about 1.3 M, about 1.4 M or about 1.5 M, or values therebetween.

In some embodiments, an energy storage device can include a liquid solvent. The solvent need not dissolve every component, and need not completely dissolve any component, of the electrolyte. In further embodiments, the solvent can be an organic solvent. In some embodiments, a solvent can include one or more functional groups selected from dioxathiolane (e.g., 1,3,2-dioxathiolane-2,2-dioxide (i.e., “DTD”)), carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), 1,3-propene sultone (PRS), and combinations thereof. In some embodiments, one or more solvents can be used at a concentration of, of about, of at least, or at least about, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. % or 90 wt. %, or any range of values therebetween. In some embodiments, solvents are utilized as additives in the electrolyte system, and can be used at a concentration of, of about, of at most, or at most about, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3 wt. %, 4 wt. %, 5 wt. %, 6 wt. %, 7 wt. %, 8 wt. %, 9 wt. % or 10 wt. %, or any range of values therebetween. For example, in some embodiments, the amount of an additive in the electrolyte is or is about in any one of the following ranges: 0.1-10 wt. %, 1-6 wt. %, 2-5 wt. %, 0.1-6 wt. %, 2-8 wt. %, 2-3 wt. %, or 1-4 wt. %.

In some embodiments, an energy storage device comprises a separator, an anode electrode, a cathode electrode, an electrolyte, and a housing, wherein the electrolyte, separator, anode electrode and cathode electrode are disposed within the housing and the separator is positioned between the anode and cathode electrodes. In some embodiments, an energy storage device is formed by placing an electrolyte, a separator, an anode electrode, and the cathode electrode described herein within a housing, wherein the separator is placed between the anode electrode and the cathode electrode. In some embodiments, the energy storage device is a battery. In some embodiments, the energy storage device is a lithium-ion battery.

In some embodiments, the energy storage device may comprise one or more separators. In some embodiments, the one or more separators is in the form of a laminate that has a pre-determined amount of thickness, for example, in the range of 1-50 μm. In some embodiments, the one or more separators, is about, is at least, or is at least about, 1 μm, 2 μm, 3 μm, 4 μm, 5 μm, 6 μm, 7 μm, 8 μm, 9 μm, 10 μm, 15 m, 20 μm, 30 μm, 40 μm or 50 μm, or any range of values therebetween (e.g. 5-10 μm). Furthermore, in some embodiments, the one or more separators is electrically insulative. In some embodiments, the one or more separators may comprise a polymeric material. In some embodiments, the one or more separators may be selected from polyethylene, polypropylene, or combinations thereof. In some embodiments, the one or more separators comprise multiple separator layers. In some embodiments, the one or more separators comprise micro-pores. In some embodiments, the one or more separators are enabled at a temperature of, of about, of at most, or of at most about, 15° C., 16° C., 17° C., 18° C., 19° C., 20° C., 21° C., 22° C., 23° C., 24° C., 25° C., 26° C., 27° C., 28° C., 29° C. or 30° C., or any range of values therebetween. In some embodiments, the one or more separators are adhered or bonded to an electrode film. In some embodiments, the separator adhered to an activated electrode film has about, at least, or at least about 1 time, 2 times, 3 times, 4 times, 5 times, 6 times, 7 times, 8 times, 9 times or 10 times, or any range of values therebetween, material transfer compared to a non-activated electrode film.

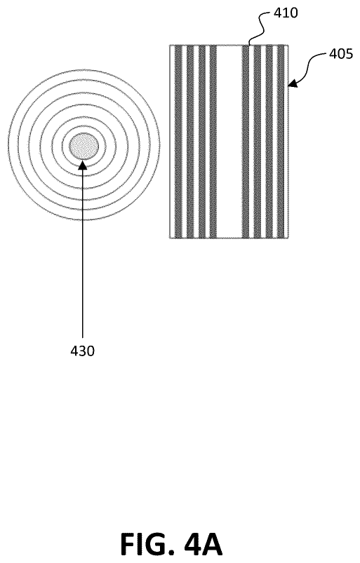

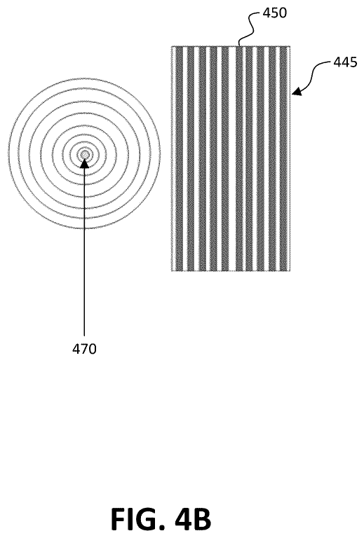

An energy storage device as provided herein can be of any suitable configuration, for example planar, spirally wound, button shaped, or pouch. In some embodiments, the cathode, anode, and separators disposed over one another are rolled together to form a jelly-roll design. A plasma treated energy storage device may provide improved flexibility in cell core size, and a height increase of electrode cells with reduced risk of core collapse. Energy storage devices can further be assembled with a wider electrode thickness. FIG. 4A is a schematic of cross sections of a jellyroll energy storage device using non-activated electrodes. An energy storage device 405 includes non-activated electrodes 410 along with a large cell core 430. FIG. 4B is a schematic of cross sections of a jellyroll energy storage device using activated electrodes. A plasma treated energy storage device 445 includes activated electrodes 450 along with a relatively smaller or non-existent cell core 470.

In some embodiments, the energy storage device comprises a cell core of, of about, of at most, or at most about, 1 mm, 2 mm, 3 mm, 4 mm, 5 mm, 6 mm, 7 mm, 8 mm, 9 mm, 10 mm, 11 mm or 12 mm, or any range of values therebetween.

### EXAMPLES

Example embodiments of the present disclosure, including processes, materials and/or resultant products, are described in the following examples.

### Example 1—Atmospheric Plasma Treatment Process

An atmospheric plasma treatment process was used to treat an electrode film. The cathode electrode film included an NMC active material of 90-97 wt. %, conductive carbon of at most 1 wt. %, and PTFE of at most 2 wt. %. The anode electrode film included a graphite active material of 90-97 wt. %, PVDF of at most 1 wt. %, and PTFE of at most 3 wt. %.

A low temperature plasma utilized a gas selected from N₂ (with nitrogen gas concentration at most about 0.1 vol. %), N₂/H₂, Ar/H₂, and Ar/O₂ mixture. The plasma process was operated between 200 W and 500 W. The operating pressure was about 3 to 5 atm while the treatment time of the electrode film was approximately 0.1 to 10 seconds. The plasma flow rate was further controlled at 0.1 to 100 L/min. As shown in Table 1, the plasma process achieved 0 to 10° contact angles between the liquids (i.e., water and electrolytes) and the electrode film for Electrodes 1-3.

TABLE 1

| | Gas | Electrode Temperature | |
|---|---|---|---|
| Electrode # | Type | Post Treatment (° C.) | Contact Angle (°) |
| 1 | N₂ | 60° C. | 0° |
| 2 | N₂/H₂ | 60° C. | 10° |
| 3 | Ar/H₂ | 25° C. | 0° |

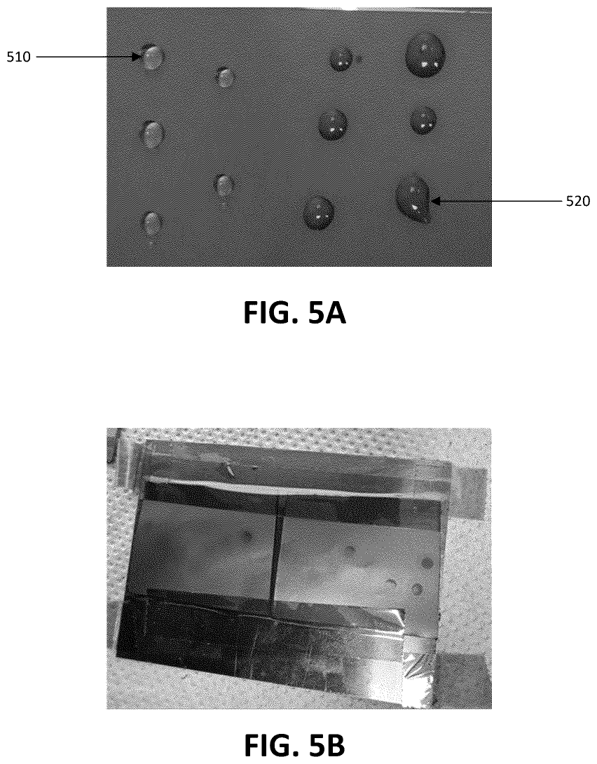

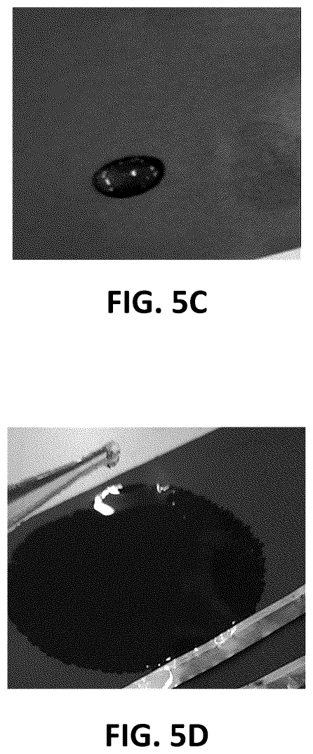

FIG. 5A is an image of liquid droplets on a non-activated electrode film. As shown in FIG. 5A, the non-activated electrode film has hydrophobic-like characteristics, creating a large contact angle between the liquids, such as water droplets 510 and electrolyte droplets 520 and the solid surface. FIG. 5B is an image of liquid droplets on an activated electrode film treated using the atmospheric plasma process. As shown in FIG. 5B, the activated electrode film has hydrophilic-like characteristics, creating contact angles between 0 to 10°.

### Example 2—Vacuum Plasma Treatment Process

A vacuum plasma treatment process was used to activate an electrode. Cathode and anode electrodes with similar compositions described in Example 1 were utilized. The plasma treatment was performed on the electrode using H₂ as a source of plasma ionizing gas, while the plasma operating power was set to 4000 W. The operating pressure was maintained at about 0.2 Pa, and the treatment time was approximately set at 1, 2, 5, 10, and 20 minutes. Treatment times at 5, 10, and 20 minutes provided improved electrode wetting properties, including a contact angle of 0° between the electrolyte and the activated electrode film surface.

FIG. 5C is an image of a liquid droplet on a non-activated electrode film. As shown in FIG. 5C, the non-activated electrode film has hydrophobic-like characteristics, creating a large contact angle between the liquid and the solid surface. FIG. 5D is an image of a liquid droplet on an activated electrode film treated using the vacuum plasma process. As shown in FIG. 5D, the activated electrode film has hydrophilic-like characteristics, creating a contact angle of about 0°.

### Example 3—Contact Angle Measurements

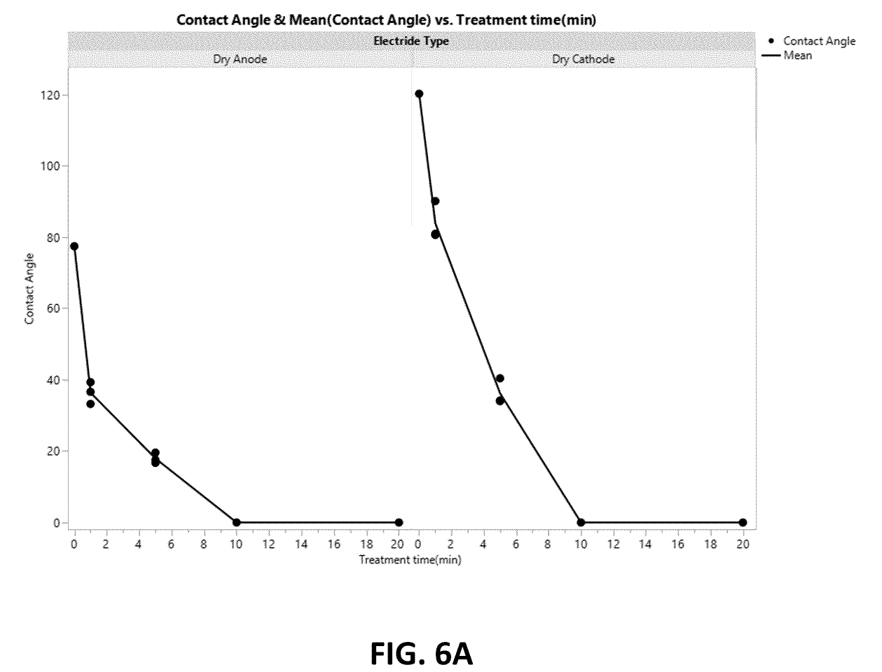

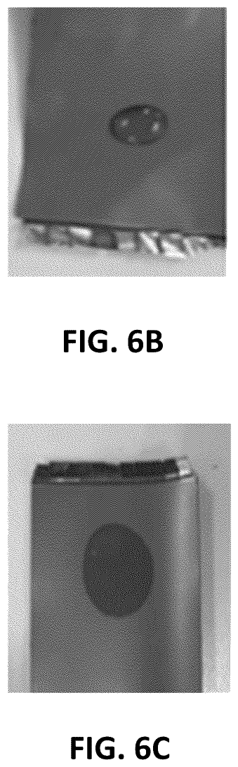

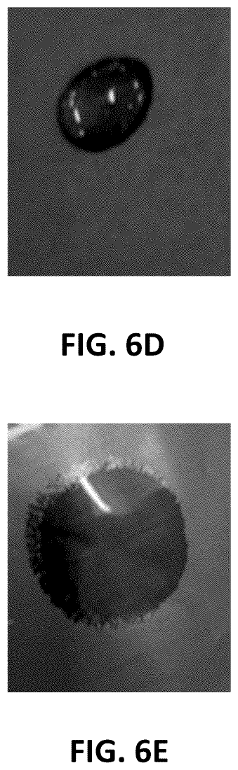

Constant angles for the electrodes using the plasma treatment process in Example 2 was measured over a period of treatment time. FIG. 6A is a plot showing contact angle vs. treatment time on a dry anode and cathode. For both activated dry anodes and cathodes, a contact angle of 0° was achieved within 10 minutes of plasma treatment time. FIGS. 6B-6E show images of droplets measured in the plot of FIG. 6A. FIG. 6B is an image of a liquid droplet on an activated dry anode before plasma treatment, showing a large contact angle between the liquid and the solid surface. FIG. 6C is an image of a liquid droplet on an activated dry anode at about 10 minutes of plasma treatment time, showing relatively small or about 0° contact angle. FIG. 6D is an image of a liquid droplet on an activated dry cathode before plasma treatment time, showing a large contact angle between the liquid and the solid surface. FIG. 6E is an image of a liquid droplet on an activated dry cathode at about 10 minutes of plasma treatment time, showing relatively small or about 0° contact angle.

### Example 4—Fully Wetting Electrodes and Energy Storage Devices

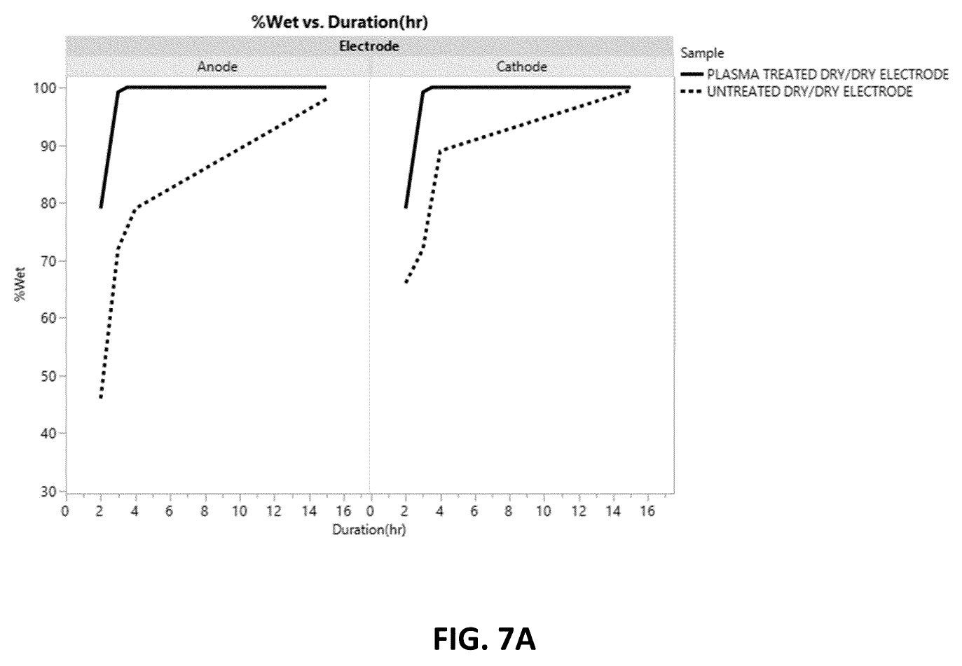

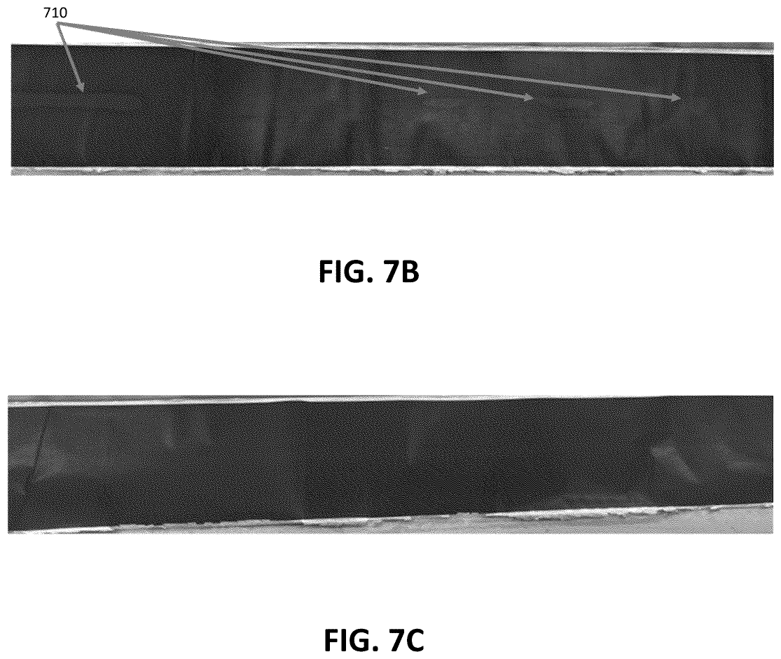

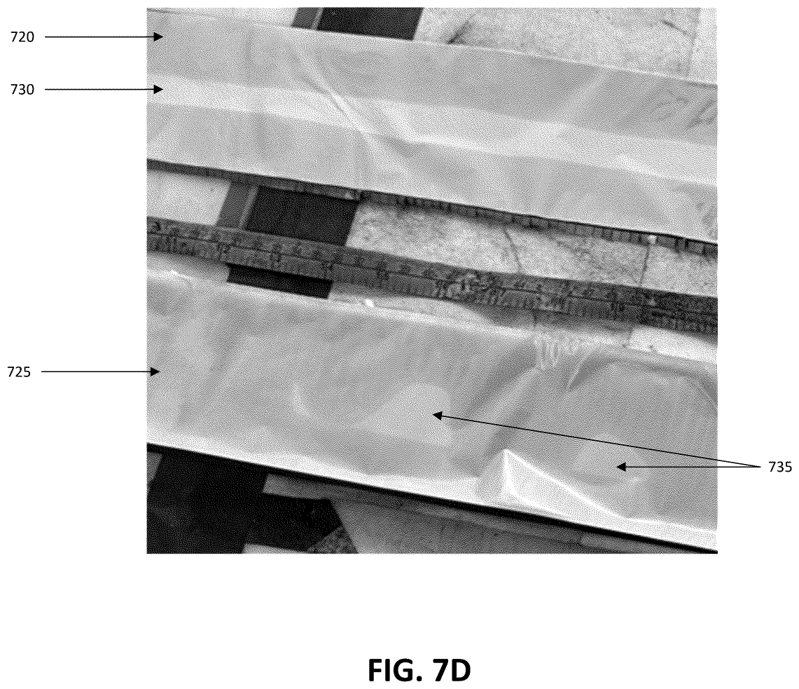

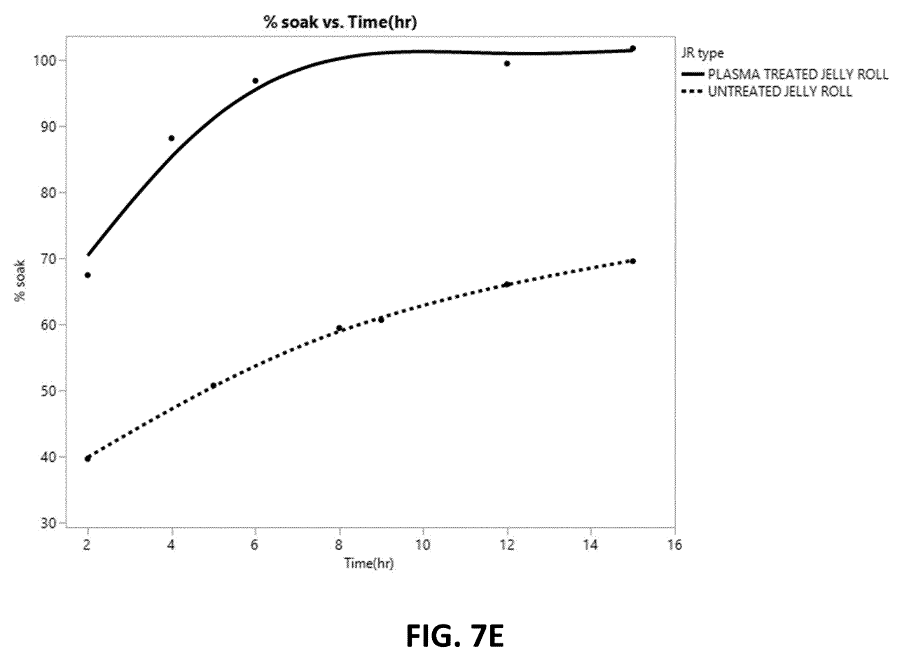

An electrode is considered fully wet when the electrode is incapable of absorbing any additional electrolytes. The wettability of electrodes based on electrode films from Example 2 showed improved wetting time. FIG. 7A is a data plot showing wetting % vs. duration comparing plasma treated dry electrodes against untreated dry electrodes. The wetting % was calculated as the ratio of wet region area to dry region area on a given electrode surface. The wetting experiment of plasma treated dry anodes and cathodes showed that plasma enabled the electrodes to achieve 100% wetting in less than 3 hours. In comparison, non-treated or non-activated electrodes required more than 16 hours to achieve 100% wetting.

FIG. 7B is an image of dry spots 710 on a non-treated electrode. In comparison, FIG. 7C is an image of a fully wet and activated electrode without visible dry spots. FIG. 7D is an image of an anode and a cathode with dry spots. As shown in FIG. 7D, wet area 720 of the anode is compared to anode dry spots 730. Likewise, wet area 725 of the cathode is compared to cathode dry spots 735.

The soaking ability of energy storage devices based on electrode films from Example 2 showed improved absorption time. The energy storage devices (e.g., plasma treated and non-plasma treated) were pre-weighed on a scale and dipped into separate beakers containing equal amounts of electrolytes. The energy storage devices were soaked over period of 2-to-3-hour intervals and their weights were recorded. FIG. 7E is a data plot showing soak % vs. duration comparing plasma treated dry electrodes with untreated dry electrodes. The plasma treated dry electrodes achieved peak electrolyte absorption 100% soak in less than 5 hours while the untreated dry electrodes achieved only 60% electrolyte soak in 16 hours. An extended experiment (not shown) demonstrated that untreated dry electrodes required approximately 72 hours to achieve 100% absorption. Table 2 shows the tabulated results of FIG. 7E.

TABLE 2

| | Time | Dry | Post-Soak | Delta | Soak |
|---|---|---|---|---|---|
| Electrode Type | (hr) | Weight | Weight | Mass (g) | % |
| UNTREATED | 2 | 247.98 | 266.6 | 18.6 | 39.6 |
| ELECTRODE | | | | | |
| PLASMA TREATED | 2 | 255.2 | 286.9 | 31.7 | 67.4 |
| ELECTRODE | | | | | |
| UNTREATED | 5 | 261.124 | 285 | 23.8 | 50.7 |
| ELECTRODE | | | | | |
| PLASMA TREATED | 4 | 255.2 | 296.65 | 41.4 | 88.1 |
| ELECTRODE | | | | | |
| UNTREATED | 8 | 261 | 288.93 | 27.9 | 59.4 |
| ELECTRODE | | | | | |
| PLASMA TREATED | 6 | 252.911 | 298.394 | 45.5 | 96.8 |
| ELECTRODE | | | | | |
| UNTREATED | 9 | 261.1 | 289.6 | 28.5 | 60.6 |
| ELECTRODE | | | | | |
| UNTREATED | 12 | 261.1 | 292.1 | 31.0 | 66 |
| ELECTRODE | | | | | |
| PLASMA TREATED | 12 | 254.9 | 301.6 | 46.7 | 99.4 |
| ELECTRODE | | | | | |
| UNTREATED | 15 | 261.1 | 293.8 | 32.7 | 69.5 |
| ELECTRODE | | | | | |
| PLASMA TREATED | 15 | 254.9 | 302.7 | 47.8 | 101.7 |
| ELECTRODE | | | | | |

### Example 5—Energy Storage Device Performances Based on Soaking Time

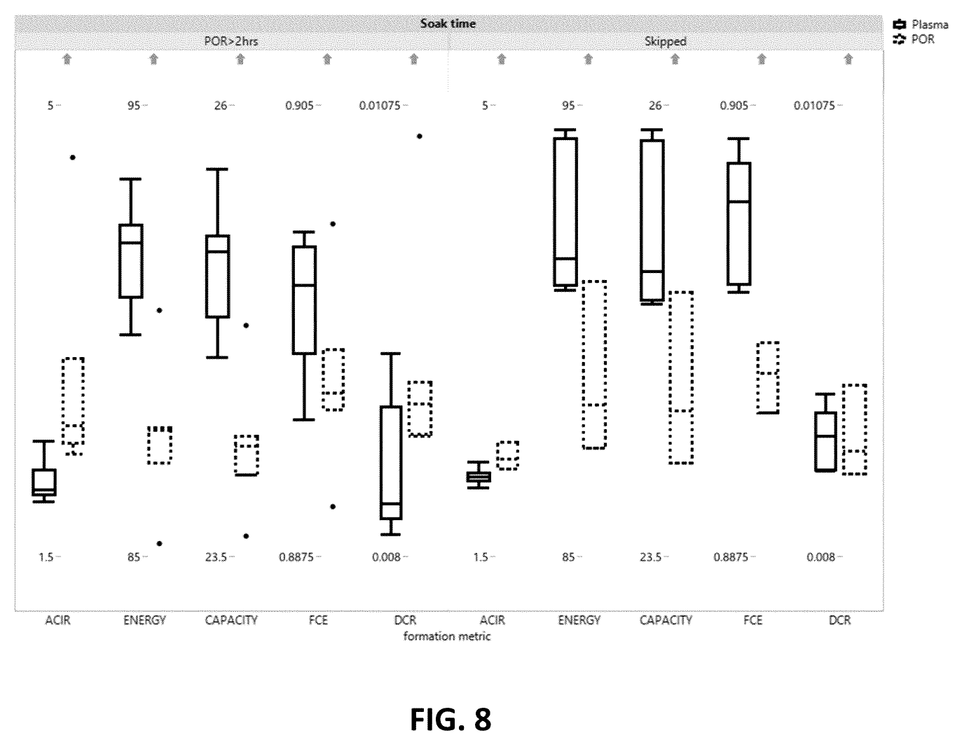

The energy storage devices based on electrode films from Example 2 showed improved energy performance with reduced soaking time. FIG. 8 is a data plot showing a summary of energy storage device performances based on soaking time comparing plasma treated dry electrodes against untreated dry electrodes. A first group of energy storage devices (with activated and non-activated electrodes) were soaked prior to formation (denoted as “POR>2 hours”). A second group of energy storage devices (with activated and non-activated electrodes) skipped the soaking step (denoted as “skipped”). By utilizing a plasma treated electrode, it was unexpectedly demonstrated that a soaking step of less than 2 hours (e.g., “skipped” soaking time) showed improved cell performances compared to Process of Record (e.g., POR electrodes soaked longer than 2 hours). As shown in FIG. 8, in comparison to non-treated cells, many of the cell performance parameters were increased. Furthermore, none of the plasma treated electrode cells showed cell degradation. For example, for plasma treated electrode cells, cell energy increased from 88 to 92 Wh and cell capacity increased from 24 to 25 mAh. Additionally, all of the other parameters including the first cycle efficiency (FCE), the discharge capacity retention (DCR), and the alternating current internal resistance (ACIR) experienced an increase in performance.

### Example 6—Energy Storge Device Performance Based on Cell Cycling

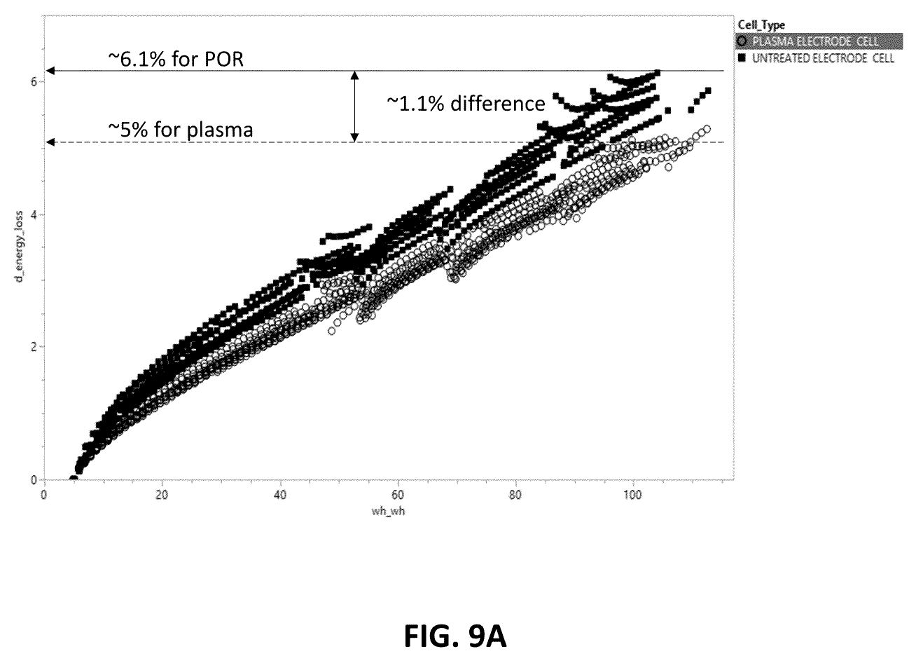

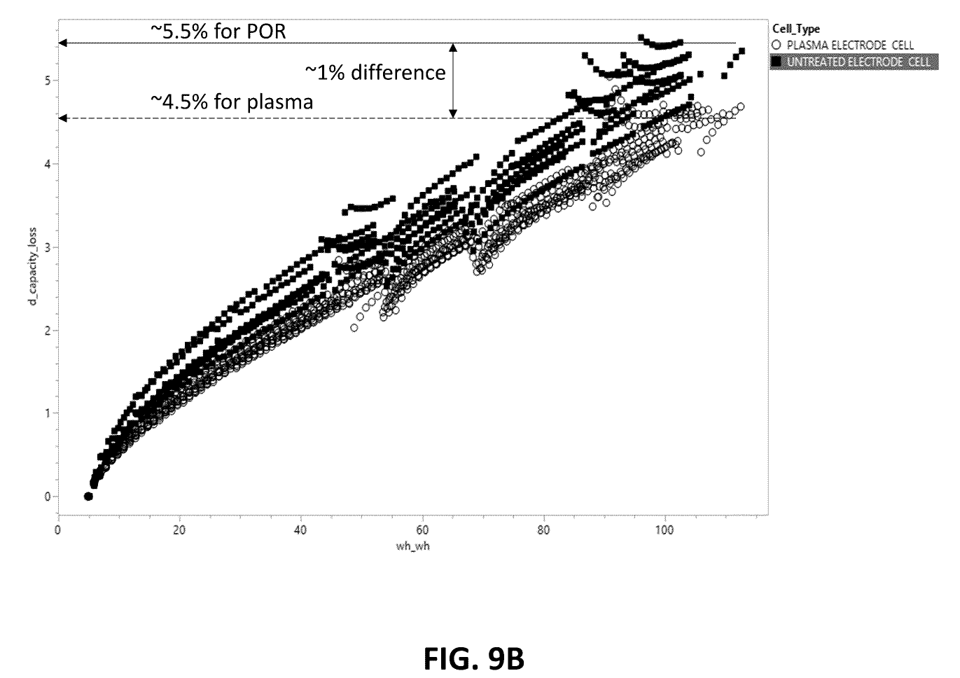

The energy storage devices based on electrode films from Example 2 showed improved energy performance when subjected to cell cycling. FIG. 9A is a data plot showing a summary of energy storage device performances based on cell energy loss comparing plasma treated dry electrodes against untreated dry electrodes. FIG. 9B is a data plot showing a summary of energy storage device performances based on cell capacity loss comparing plasma treated dry electrodes, according to some embodiments, against untreated dry electrodes. Plasma treated electrode cells showed improved energy retention (about 1.1%) during cycle testing and showed less energy loss (about 1%) compared to untreated electrode cells.

### Example 7—Separator Adhesion

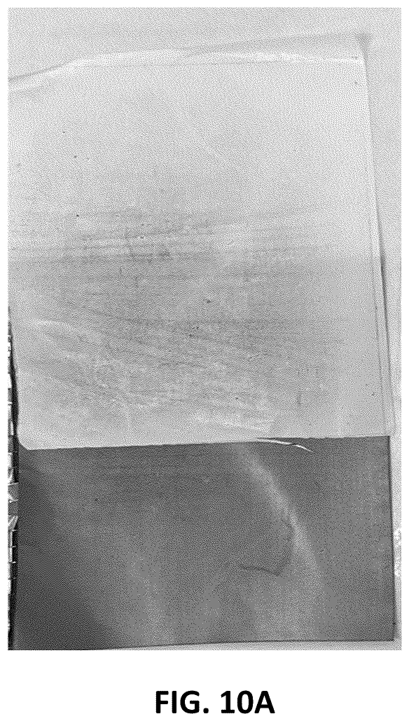

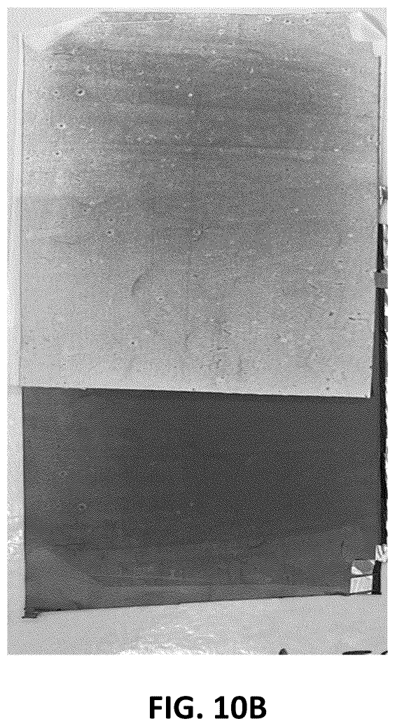

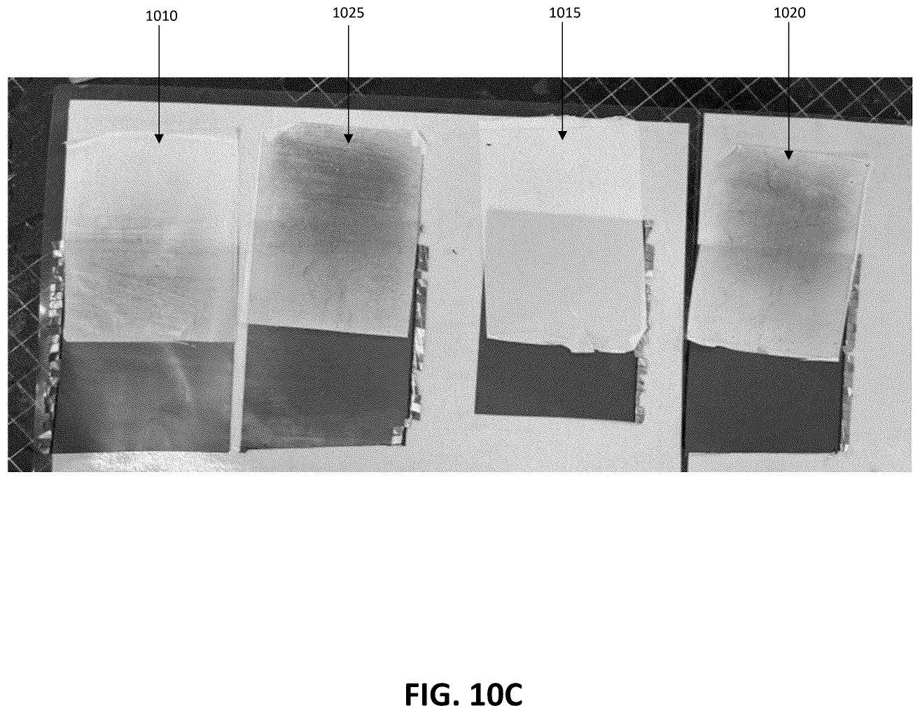

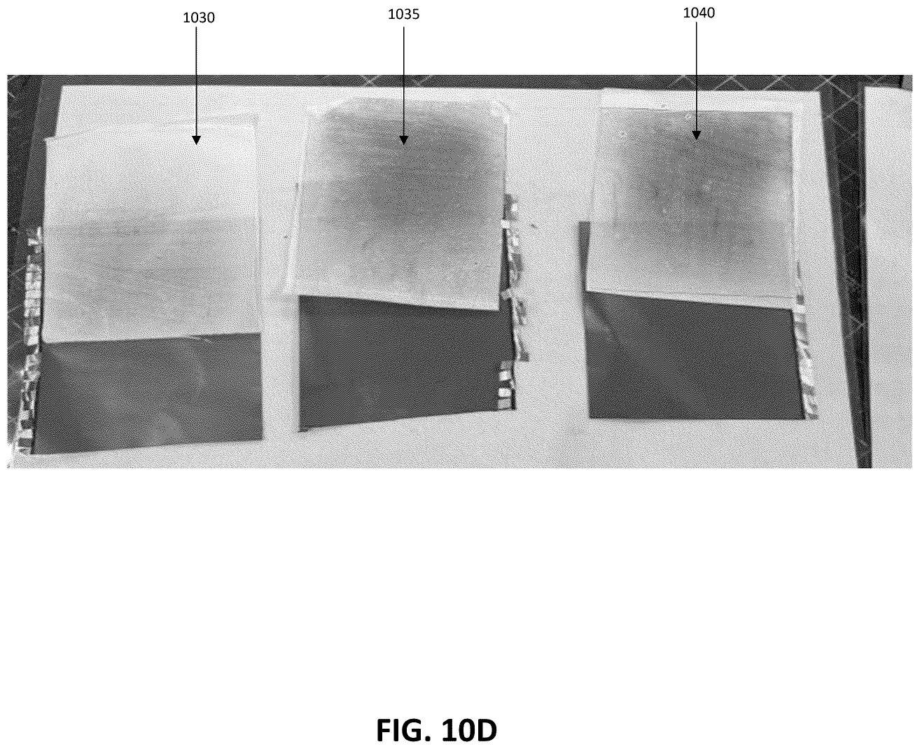

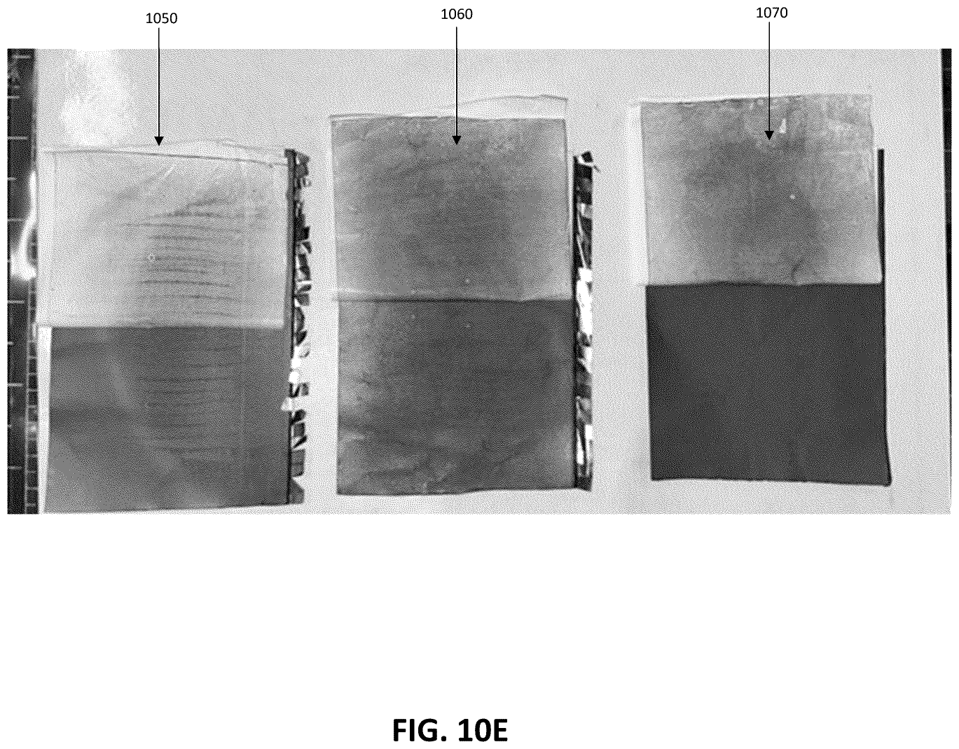

Adhesive strength between separator and electrode film increased when the activated electrode films from Example 2 were used. FIG. 10A is an image showing a separator that was adhered to a non-activated electrode film and subsequently removed from the non-activated electrode film. FIG. 10B is an image showing a separator that was adhered to an activated electrode film and subsequently removed from the activated electrode film. FIG. 10B shows that an increased amount of electrode film remained on the separator relative to that of FIG. 10A, demonstrating increased adhesive strength of the activated electrode film.

FIGS. 10C to 10E are images showing material transfer between treated and untreated separators that were adhered to treated and untreated anodes using a specific type of plasma. FIG. 10C is an image of four different samples for a plasma type A at 45° C. An untreated anode and untreated separator 1010 provided low adhesion, and likewise an untreated anode and treated separator 1015 provided low adhesion. In contrast, a treated anode and treated separator 1020 combination provided medium adhesion, and a treated anode and untreated separator 1025 provided medium-high adhesion properties.

FIG. 10D is an image comparing the material transfer between a treated anode and untreated separator using two different plasma types at 45° C. An untreated anode and untreated separator 1030 provided low adhesion. A treated anode and untreated separator using plasma type A 1035 provided medium-high adhesion properties while plasma type B 1040 provided high adhesion properties. Similarly, FIG. 1 is an image comparing the material transfer between a treated anode and an untreated separator using two different plasma types at 60° C. An untreated anode and untreated separator 1050 provided low adhesion. A treated anode and untreated separator using plasma type A 1060 and plasma type B 1070 both provided high adhesion properties.

Table 3 shows the results of the image analysis technique which was used to quantify the material transfer and bonding between the electrode film and the separator. Various combinations of untreated and treated anodes and untreated and treated separators were compared using the image analysis technique. Plasma Type A included hydrogen gas in vacuum plasma with 10 minutes of treatment time while Plasma Type B included hydrogen gas in vacuum plasma with 20 minutes of treatment time.

TABLE 3

| | Samples | | | | | |
|---|---|---|---|---|---|---|
| | Anode (U) | Anode (T) | Anode (U) | Anode (T) | | |
| Plasma | Separator | Separator | Separator | Separator | Pressure | Temperature |
| Type | (U) | (U) | (T) | (T) | (MPa) | (° C.) |
| A | Low | Medium- | Low | Medium | ~0.5 MPa | 45° C. |
| | Adhesion | High | Adhesion | Adhesion | | |
| | | Adhesion | | | | |
| B | Low | High | N/A | N/A | ~0.5 MPa | 45° C. |
| | Adhesion | Adhesion | | | | |
| A | Low | High | N/A | N/A | ~0.5 MPa | 60° C. |
| | Adhesion | Adhesion | | | | |
| B | Low | High | N/A | N/A | ~0.5 MPa | 60° C. |
| | Adhesion | Adhesion | | | | |

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method of fabricating an activated electrode film, comprising:
providing an electrode film comprising an active material and a binder; and
plasma treating the electrode film with a plasma formed from an activating gas to form an activated electrode film comprising an activated binder.

2. The method of claim 1, wherein the activating gas comprises a gas selected from the group consisting of hydrogen gas, nitrogen gas, argon gas, oxygen gas and combinations thereof.

3. The method of claim 2, wherein the activating gas comprises nitrogen gas at a concentration of at most about 0.1 vol. %.

4. The method of claim 1, wherein plasma treating the electrode film operates at a pressure of at most about 5 atm.

5. The method of claim 1, wherein plasma treating the electrode film operates at a pressure of about 0 atm.

6. The method of claim 1, wherein the activated electrode film is substantially free of solvent residue.

7. The method of claim 1, wherein the activated electrode film is disposed over a current collector to form an activated electrode.

8. The method of claim 1, wherein the binder is a fluorinated binder.

9. The method of claim 1, wherein the activated binder is selected from the group consisting of a defluorinated binder, a hydroxylated binder, and combinations thereof.

10. A method of preparing an energy storage device, comprising:
disposing an activated electrode within a housing; and
disposing an electrolyte within the housing,
wherein the activated electrode absorbs the electrolyte to form a fully wet activated electrode.

11. The method of claim 10, wherein the electrolyte is disposed after the activated electrode is disposed within the housing.

12. The method of claim 10, wherein the energy storage device absorbs the electrolyte to form a fully soaked electrode energy storage device in at most about 5 hours.

13. The method of claim 10, further comprising enabling complete wetting of the activated electrode in less than about 3 hours.

14. The method of claim 10, wherein the electrolyte fills the activated electrode at a positive interfacial pressure.

15. The method of claim 14, wherein the positive interfacial pressure is at least about 1 atm.

16. The method of claim 14, wherein the filling of the electrolyte does not comprise an additional external pressure.

17. An activated electrode film, comprising:
an active material; and
an activated binder.

18. The activated electrode film of claim 17, further comprising at least 90 wt. % of the active material.

19. The activated electrode film of claim 17, wherein the active material is selected from at least one of a metal oxide, metal sulfide, a sulfur-carbon composite, a lithium metal oxide, and a material including sulfur.

20. The activated electrode film of claim 17, further comprising at most about 5 wt. % of the activated binder.

21. The activated electrode film of claim 17, wherein the activated binder is selected from the group consisting of defluorinated polyvinylidene fluoride (PVDF), defluorinated polytetrafluoroethylene (PTFE), polyethylene (PE), polypropylene (PP), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, carboxymethylcellulose (CMC), co-polymers thereof and combinations thereof.

22. The activated electrode film of claim 17, wherein the activated binder is selected from the group consisting of a defluorinated binder, a hydroxylated binder, and combinations thereof.

23. The activated electrode film of claim 17, wherein the activated electrode film is substantially free of solvent residue.

24. The activated electrode film of claim 17, wherein the activated electrode film comprises at most about 1 wt. % of non-activated binder.

25. The activated electrode film of claim 17, further comprising an activated film thickness comprising the activated binder.

26. The activated electrode film of claim 25, wherein the activated film thickness is at least about 20 μm.

27. The activated electrode film of claim 17, wherein the activated electrode film comprises a contact angle of at most about 20°.

28. The activated electrode film of claim 17, wherein the activated electrode film comprises a contact angle of about 0°.
